(19) United States
(12) Patent Application Publication
(10) Pub. No.: US 2023/0153402 A1
(43) Pub. Date: May 18, 2023

(54) SYSTEM AND METHOD FOR DETERRING DATA LEAKAGE THROUGH PHOTOGRAPHING OF DISPLAY SCREEN BY EXTERNAL CAMERA

(71) Applicant: INFOSYS LIMITED, Bangalore (IN)

(72) Inventor: Srinivas POOSARLA, Bangalore (IN)

(21) Appl. No.: 17/705,338

(22) Filed: Mar. 27, 2022

(30) Foreign Application Priority Data
Nov. 16, 2021 (IN) 202141052408
Mar. 25, 2022 (IN) 2021 41052408

(51) Int. Cl. G06F 21/16; G06F 21/62; G06F 40/205

(52) U.S. Cl. CPC G06F 21/16; G06F 21/6245; G06F 40/205

(57) ABSTRACT

A system and/or a method for deterring data leakage through photographing of display screen by external camera. A digital content displayed on the digital device is detected, and a classification type of the digital content is identified. When the classification type is one of the predefined types, the user information associated with the digital device is obtained based on which a visual noise to be displayed on the digital device is fetched from database. The fetched visual noise is displayed along with the digital content to deter the leakage of information from the displayed digital content through an external image capturing device. The visual noise that is displayed comprises either or combination of: modifying, at least one character in the digital content with the visual noise or overlaying the visual noise on the at least one character in the digital content.

This application claims the benefit of Non-Provisional Indian Patent Application No. 202141052408, filed on Mar. 25, 2022, which claims the benefit of Indian Provisional Patent Application No. 202141052408, filed on Nov. 16, 2021, which are incorporated by reference in their entirety.

### FIELD

The field generally relates to cyber security. In particular, the present technique relates to system and/or method for deterring data leakage through photographing of display screen by camera of external digital device.

### BACKGROUND

At present, we all are witnessing generation and dissemination of information at a scale that human race never witnessed. With the revolution in digital data sharing, the distance and time between two digital endpoints to share data is getting thinner day by day. Every information that is generated may not be meant for sharing. For example, confidential information or internal data of any organization.

Currently, within an enterprise domain, there are methods to avoid leakage of such information by disabling the capability of end points/digital devices to take snapshot of the screen on which the confidential information is displayed. This will help to mitigate leakage of information by the end points/digital devices, but the chances of capturing image of the screen using an external image capturing device, such as a digital camera embedded in smartphone, is still a matter of concern.

Hence, there is a need for a technical solution to overcome the above-mentioned problem, particularly in post-pandemic era when remote or hybrid work models may be a more common practice.

### SUMMARY

Disclosed is a system and/or a method for deterring data leakage through photographing of display screen by camera of external digital device.

In one aspect, a method for deterring data leakage through photographing of display screen by external camera is disclosed. The method comprising, detecting a digital content displayed on the digital device, wherein the digital content is either or combination of an image or a text document. A classification type of the digital content that is displayed on the digital device is identified. When the classification type of the digital content is one of the pre-defined types, an information of a user associated with the digital device is obtained from the enterprise database based on which a visual noise to be displayed on the digital device is determined and fetched from the enterprise database. The fetched visual noise is displayed along with the digital content to deter the leakage of information from the displayed digital content through image capture by an external image capturing device (or external camera). The visual noise that is displayed comprising either or combination of: modifying one or more characters in the digital content with the visual noise and/or overlaying the visual noise on the digital content.

The visual noise that are fetched from the enterprise database, which is unique for each user is generated using a data pattern based on the information of the user and one or more pre-defined rules for the user associated with the digital device, wherein the visual noise is at least one or combination of alphanumeric characters special characters, and/or graphical content.

In another aspect, a system for deterring data leakage through photographing of display screen by an external camera is disclosed, comprising at least one processor, a digital device, at least one memory unit operatively coupled to the at least one processor, having instructions stored thereon that, when executed by the at least one processor, causes the at least one processor to detect a digital content displayed on the digital device, wherein the digital content is either or combination of an image or a text document. A classification type of the digital content that is displayed on the digital device is identified. When the classification type of the digital content is one of the pre-defined types, an information of a user associated with the digital device is obtained from the enterprise database based on which a visual noise to be displayed on the digital device is determined and fetched from the enterprise database. The fetched visual noise is displayed along with the digital content to deter the leakage of information from the displayed digital content through image capture by an external image capturing device (or external camera). The visual noise that is displayed comprising either or combination of: modifying one or more characters in the digital content with the visual noise and/or overlaying the visual noise on the digital content.

The visual noise that are fetched from the enterprise database, which is unique for each user is generated using a data pattern based on the information of the user and one or more pre-defined rules for the user associated with the digital device, wherein the visual noise is at least one or combination of alphanumeric characters special characters, and/or graphical content.

In yet another aspect, a non-transitory computer readable medium having stored thereon instructions for deterring data leakage through photographing of display screen by an external camera, the non-transitory computer readable medium comprising machine executable code which when executed by at least one processor, causes the at least one processor to perform steps comprising, detecting a digital content displayed on the digital device, wherein the digital content is either or combination of an image or a text document. A classification type of the digital content that is displayed on the digital device is identified. When the classification type of the digital content is one of the pre-defined types, an information of a user associated with the digital device is obtained from the enterprise database based on which a visual noise to be displayed on the digital device is determined and fetched from the enterprise database. The fetched visual noise is displayed along with the digital content to deter the leakage of information from the displayed digital content through image capture by an external image capturing device (or external camera). The visual noise that is displayed comprising either or combination of: modifying one or more characters in the digital content with the visual noise and/or overlaying the visual noise on the digital content.

The visual noise that are fetched from the enterprise database, which is unique for each user is generated using a data pattern based on the information of the user and one or more pre-defined rules for the user associated with the digital device, wherein the visual noise is at least one or combination of alphanumeric characters special characters, and/or graphical content.

The system, the method, and/or the non-transitory computer readable storage medium disclosed herein may be implemented in any means for achieving various aspects and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE FIGURES

Examples are illustrated by way of example and not limitation in the figures of the accompanying drawings, in which like references indicate similar elements and in which:

FIG. 1 is a diagrammatic representation of a data processing system capable of processing a set of instructions to perform any one or more of the methodologies herein, according to one or more examples.

FIG. 2 is an architecture diagram illustrating plurality of components of system for deterring data leakage through photographing of display screen by external camera, according to one or more examples.

FIG. 3 is a process flow diagram illustrating sequence of steps executed by the system for deterring data leakage through photographing of display screen by external camera, according to one or more examples.

FIG. 4 is an exemplary digital content, according to one or more examples.

FIG. 5 is an illustration of visual noise introduced by the system for deterring data leakage through photographing of display screen by external camera, according to one or more examples.

Other features of the present examples will be apparent from the accompanying drawings and from the detailed description that follows.

### DETAILED DESCRIPTION

As mentioned in the background section, in recent times, the application are configured to disable the capability of end points/digital devices to take snapshot of the screen, but taking the picture of screen using external camera is still possible. Examples of this technology in the present disclosure are aimed to overcome the problem mentioned in the background section with a solution which acts as a deterrent for data leakage through screen capture by an external image capturing device. When a user of organization leaks confidential information to outside world by capturing image of confidential documents displayed on devices provided by organization, based on the noise present in the image which are introduced beforehand using technology described in the present disclosure, it is possible to backtrack and find out that user who leaked the information which helps in investigation and acts as deterrent for user to capture image using external camera.

In one or more examples, a system and/or a method for deterring data leakage through photographing of display screen by external camera is disclosed, and the method comprising, detecting a digital content displayed on the digital device, wherein the digital content is either or combination of an image or a text document. A classification type of the digital content that is displayed on the digital device may be identified. When the classification type of the digital content is one of the pre-defined types, an information of a user associated with the digital device may be obtained from the enterprise database based on which a visual noise to be displayed on the digital device is determined and fetched from the enterprise database. The fetched visual noise may be displayed along with the digital content to deter the leakage of information from the displayed digital content through image capture by an external image capturing device (or external camera). The visual noise that is displayed comprising either or combination of: modifying one or more characters in the digital content with the visual noise and/or overlaying the visual noise on the digital content.

The visual noise that are fetched from the enterprise database, which is unique for each user may be generated using a data pattern based on the information of the user and one or more pre-defined rules for the user associated with the digital device, wherein the visual noise is at least one or combination of alphanumeric characters special characters, and/or graphical content.

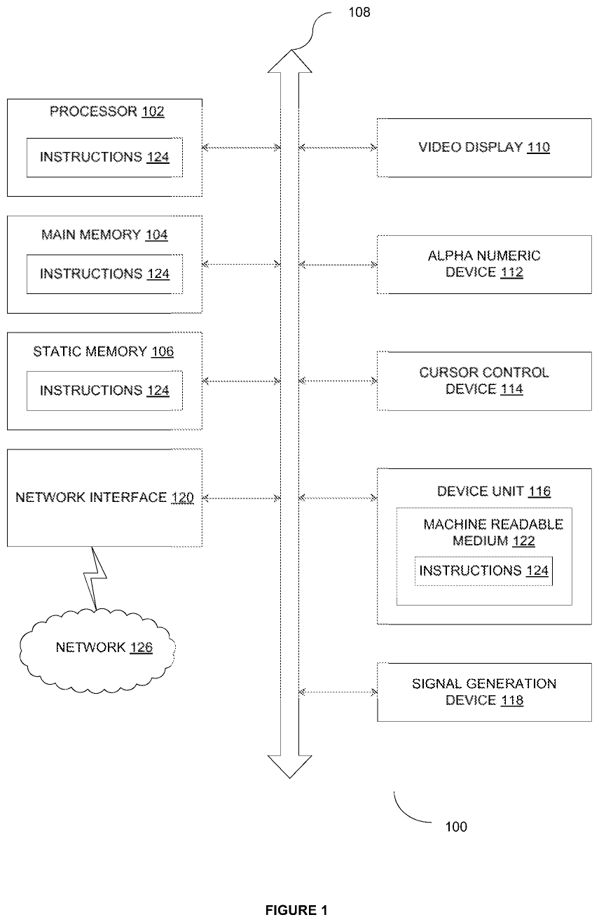

FIG. 1 is a diagrammatic representation of a data processing device capable of processing a set of instructions to perform any one or more of the methodologies herein, according to one example. FIG. 1 shows a diagrammatic representation of machine and/or the data processing device in the example form of a computer system 100 within which a set of instructions, for causing the machine to perform any one or more of the methodologies discussed herein, may be executed. In various examples, the machine operates as a standalone device and/or may be connected (e.g., networked) to other machines.

In a networked deployment, the machine may operate in the capacity of a server and/or a client machine in server-client network environment, and/or as a peer machine in a peer-to-peer (or distributed) network environment. The machine may be a personal-computer (PC), a tablet PC, a set-top box (STB), a Personal Digital Assistant (PDA), a cellular telephone, a web appliance, a network router, switch and/or bridge, an embedded system and/or any machine capable of executing a set of instructions (sequential and/or otherwise) that specify actions to be taken by that machine. Further, while only a single machine is illustrated, the term “machine” shall also be taken to include any collection of machines that individually and/or jointly execute a set (or multiple sets) of instructions to perform any one and/or more of the methodologies discussed herein.

The example computer system 100 includes a processor 102 (e.g., a central processing unit (CPU) a graphics processing unit (GPU) and/or both), a main memory 104 and a static memory 106, which communicate with each other via a bus 108. The computer system 100 may further include a video display unit 110 (e.g., a liquid crystal displays (LCD), Light Emitting Diode (LED) display and/or a cathode ray tube (CRT)). The computer system 100 also includes an alphanumeric input device 112 (e.g., a keyboard), a cursor control device 114 (e.g., a mouse), a disk drive unit 116, a signal generation device 118 (e.g., a speaker), micro controller 128 (e.g., program logic controller) and a network interface 120.

The disk drive unit 116 includes a machine-readable medium 122 on which is stored one or more sets of instructions 124 (e.g., software) embodying any one or more of the methodologies and/or functions described herein. The instructions 124 may also reside, completely and/or at least partially, within the main memory 104, within the static memory 106 and/or within the processor 102 during execution thereof by the computer system 100, the main memory 104 and the processor 102 also constituting machine-readable media.

The instructions 124 may further be transmitted and/or received over a network 126 via the network interface 120. While the machine-readable medium 122 is shown in an example to be a single medium, the term “machine-readable medium” should be taken to include a single medium and/or multiple media (e.g., a centralized and/or distributed database, and/or associated caches and servers) that store the one or more sets of instructions. The term “machine-readable medium” shall also be taken to include any medium that is capable of storing, encoding and/or carrying a set of instructions for execution by the machine and that cause the machine to perform any one or more of the methodologies of the various examples. The term “machine-readable medium” shall accordingly be taken to include, but not be limited to, solid-state memories, optical media and magnetic media.

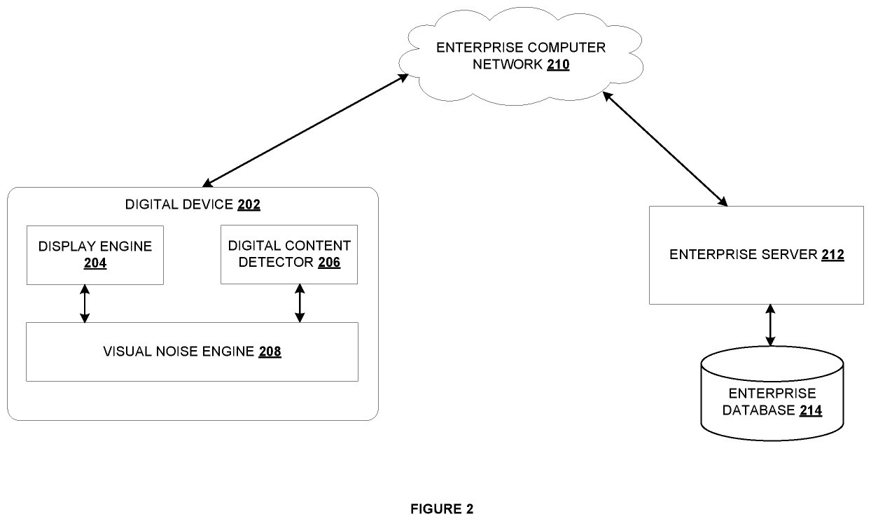

FIG. 2 is an architecture diagram illustrating plurality of components of system for deterring data leakage through photographing of display screen by an external camera (also referred as external image capturing device), according to one or more examples. In one or more examples, the system may comprise components such as, but not limited to a digital device 202 communicatively coupled to an enterprise server 212 through an enterprise computer network 210. There may be plurality of digital devices 202 communicatively coupled to the enterprise server 212 and each of the plurality of digital devices 202 may be registered with the enterprise server 212 and such information may be stored in the enterprise data store 214. The enterprise server 212 may be communicatively coupled to enterprise database 214. The enterprise database 214 may be configured to store information of user(s) and the digital device (s) associated with the user. There may be plurality of users associated with the enterprise and all the users are registered with the enterprise server 212 and such information may be stored in the enterprise data store 214. For example, in an enterprise environment, the user may be an employee and enterprise database 214 may be configured to store information related to employee/user such as, but not limited to employee ID (or employee number), location of the employee, access permissions that are granted to the employee by the organization, and/or information of digital devices such as device ID, allocation details etc. The enterprise database 214 may also be configured to store visual noise that is associated with each user, which are used to deter data leakage which will be described in subsequent paragraphs of the present disclosure. The digital device 202 (also referred as client device 202) may be an electronic device which processes and displays information, and such electronic device may include, but not limited to, desktops, laptops, tablets, peripherals, servers, mobile telephones, smartphones, and/or any similar devices. The digital device 202 may comprise one or more components such as, but not limited to a display engine 204, a digital content detector 206 and a visual noise engine 208.

In one or more examples, the display engine 204 may be configured to display digital content on the digital device 202. The digital content detector 206 may be configured to detect/identify the classification type of digital content displayed on the digital device 202. The classification type may be pre-defined by the enterprise, such as, but not limited to, internal, public and/or confidential. Generally, the internal and confidential documents may comprise information that needs to be protected from leakage and the examples described in the present disclosure deters any attempt to leak data or information that are not meant for public disclosure. The digital content detector may be configured to detect/identify the classification type of the digital content either from metadata information associated with the digital content, or by way of Optical Character Recognition (OCR) or by parsing the digital content or combination thereof.

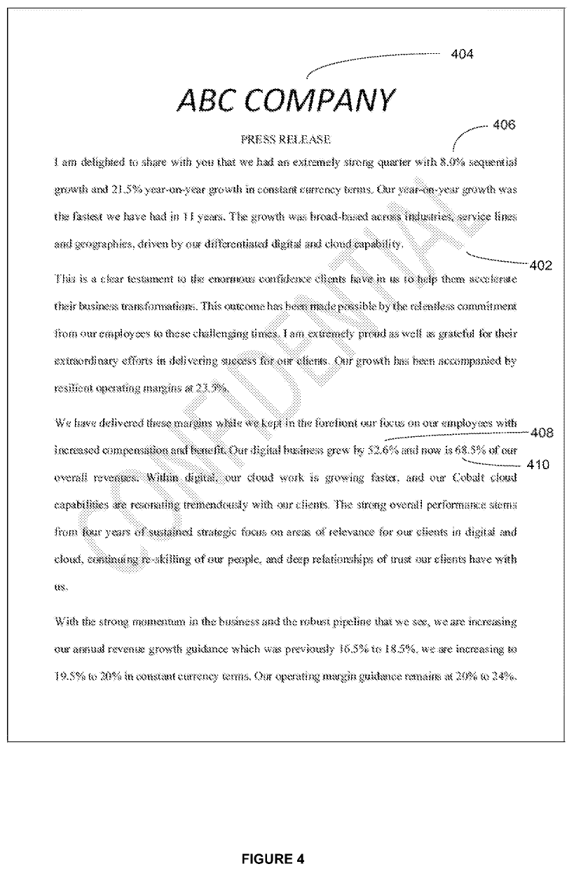

In one or more examples, the metadata present in the digital content may be parsed by the digital content detector 206 to extract the classification type information when there is any attempt to open/access the digital content at the digital device. The digital content may be stored at enterprise database 214 and may be accessed by the user through digital device connected to the enterprise server 212 over enterprise computer network 210. In some instances, the digital content may be stored locally at the digital device which are accessed by the user based on access permissions provided by the enterprise to the user or the digital device. In one way, the digital content may comprise text which explicitly mentions the classification type (as illustrated in FIG. 4). In other way, the digital content may comprise confidential names and numbers such as client names of an organization, revenue details of the organization etc. The display engine may identify the classification type of the digital content by parsing the text in the digital content. Alternatively, the display engine may extract the text through OCR techniques to identify the classification type of the digital content. On identifying that the digital content is of such classification type (for example, internal and/or confidential) that needs to be protected from data leakage, the digital content detector 206 may be configured to send one or more instructions to the visual noise engine 208. The visual noise engine 208 may be configured to obtain user information from the digital device (for example employee number or any such information that uniquely identifies the user) and fetch a visual noise to be displayed on the digital device from the enterprise database 214 through the enterprise server 212 based on the obtained user information. The enterprise database 214 may be configured to store the visual noise that is unique for each user, which are pre-defined and are mapped to each user based on user information and information of digital device associated with the user. After fetching the visual noise, the visual noise engine 208 may send one or more instructions to display visual noise along with the visual noise to the display engine 204 to cause displaying the determined visual noise along with the digital content to deter leakage of information from the displayed digital content through image capture by external image capturing device.

In one or more examples, the visual noise may be introduced either by overlaying the visual noise on top of the digital content or by modifying the digital content thereby avoiding leakage of actual information. As the actual information is not available (i.e., it is either masked or modified temporarily) and when such digital document is opened by the user at the digital device, the actual information will not be available and hence capturing such image using external camera will not result in leakage of information. With such alternate information (after introduction of visual noise either by modifying the text or masking the existing text with masked alternate values), with visual noise and user mapping information available with the enterprise, if such images are uploaded publicly by the user, the enterprise can backtrack by analyzing the publicly available image by detecting the visual noise.

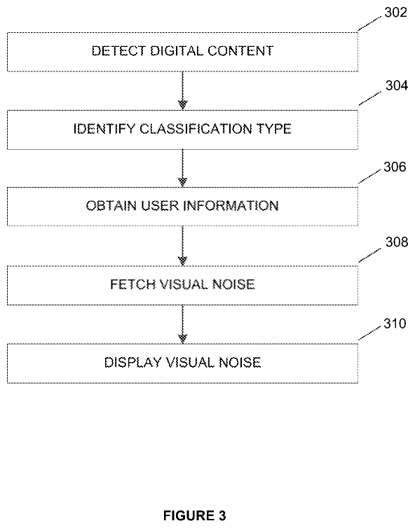

FIG. 3 is a process flow diagram illustrating sequence of steps executed by the system for deterring data leakage through photographing of display screen by an external camera, according to one or more examples. The method comprising, detecting a digital content displayed on the digital device as in step 302, wherein the digital content is either or combination of an image or a text document. A classification type of the digital content that is displayed on the digital content is identified, either by parsing metadata associated with the digital content or by parsing the digital content, as in step 304. In one or more examples, the metadata associated with the digital content may comprise information such as, but not limited to type information of the digital content which may be either a document (.pdf, .doc, .docx etc.) or an image (.jpg, .jpeg, .tiff etc.), access permission given to the user to access the digital content, size of the digital content, pixel information of the digital content (in case of images) etc.

In one example, the digital content may comprise text which explicitly mentions the classification type, for example text describing the classification type present inside the digital content. In another example, the digital content may comprise confidential names and numbers such as client names of an organization, revenue details of the organization etc. In such cases, the classification type of the digital content may be identified by parsing the digital content or though OCR technique, and relevant text that describe the classification type of the digital content is identified to find under which classification type the digital content belongs. When the classification type of the digital content is one of the pre-defined types and is of such classification type that needs to be protected from data leakage, a user information associated with the digital device is obtained as in step 306 based on which a visual noise to be displayed on the digital device is fetched from the database, as in step 308. The pre-defined classification types of the digital content that needs the data protection may be such as, but not limited to confidential, internal and/or trade secret. In an example, a user may be an employee of an organization and the user information may comprise—for example employee number or any such information that uniquely identifies the user, access permission of the user to the digital device associated with the user and/or access permission of the user to the digital content etc. A unique visual noise may be an alternative textual and/or graphical content when compared to digital content, pre-defined for each user and may be stored in the enterprise database. When the digital document is accessed at the digital device by the user, the user information stored in the digital device may be used to fetch the visual noise associated with the user that are stored in the enterprise database by way of mapping data tables. The fetched visual noise may be displayed along with the digital content as in step 310 to deter the leakage of information from the displayed digital content through an external image capturing device. The visual noise that is displayed comprises either or combination of—modifying at least one character in the digital content with the visual noise, when the digital content in editable/modifiable based on access permission associated with the digital content with the user or overlaying the visual noise on the at least one character in the digital content when the digital content is in at least one of editable and/or non-editable format.

In one example, a visual noise may be introduced in the digital content by modifying at least one character of the digital content when the digital content is editable, wherein the at least one character in the digital content may be extracted either by parsing the digital content or by OCR techniques. In another example, a visual noise may be introduced by overlaying/overlapping the visual noise over the data in the digital content when the digital content is either editable or non-editable. The visual noise to be introduced is also defined along with which data in the digital content needs to be replaced. For example, for a user, when a visual noise is defined, it is also defined as to which data needs to be replaced in case the digital content is editable and which data needs to be selected in the digital content to overlay if the digital content is non-editable.

In one or more examples, in order to identify which part of the digital content needs to be modified or overlaid with the visual noise, the digital content detector module of the system may communicate with graphical processor and display drivers of the digital device to detect whether the digital content is accessed by the user or not. When accessed, the digital content detector may identify the digital content and either parse document, parse metadata or execute OCR techniques to identify the classification type of the document and then send one or more instructions to the visual noise engine to fetch the visual noise associated with the user. The visual noise engine may communicate with the digital content detector to identify the portion in the digital content which needs to be either modified or overlaid with the visual noise and send one or more instructions along with the visual noise to the display engine to introduce noise on the digital device. In case of modification, the visual noise engine may communicate with the application through which the digital document is opened and may instruct the application to modify the content as per the visual noise. In case of overlay, the visual noise engine may communicate with the display engine which in turn may communicate with display drivers of the digital device to overlay the visual noise after identifying which section needs to be overlaid by receiving information from the digital content detector.

The visual noise that are fetched from the enterprise database, which is unique for each user is created by generating a data pattern comprising at least one character or special character, or sequence of characters or special characters, based on user information and one or more pre-defined rules for the user associated with the digital device. The visual noise may be at least one or combination of: an alphanumeric character, special character and/or graphical content.

In one or more examples, the visual noise which is unique for each user may be generated and stored in the enterprise database 214. The visual noise may be generated using an algorithm that will be visually imperceptible to the user/human eye, will have insignificant impact on readability, but can be identified uniquely when an organization finds & investigates a leaked screenshot/snapshot of information of the organization in public domain. The visual noise may be in the form of small change in few characters in various parts of the screen such as, but not limited to, font size, character type, character style, and/or color of pixels in a random pattern. But for each user the pattern y=f(x) may be unique, which may be generated statistically using the algorithm with an input (‘x’) say enterprise user ID or employee ID. The examples in the present disclosure performs dynamic watermarking/visual noise introduction for only that part of the document that shows up on the screen, and not the whole file.

In an example, the visual noise may be generated using an algorithm which may be a linear function with concatenation rule that combines the employee number with some special characters. In another example, the visual noise may be generated with unique pre-defined rules such as for an employee with employee number 122334, a font style of tenth character in the third line of a confidential document may be changed to italic so that it is imperceptible to human eye, but system can detect and backtrack it using enterprise database 214 and character recognition methodology when the information is found to be leaked to the public domain.

It is to be observed that the system continuously monitors the displayed digital content on the digital device. As mentioned in previous paragraph, if the visual noise is introduction of change in font style of tenth character in the third line of a confidential document, whenever the user scrolls down, scrolls up or scrolls in any direction while viewing/accessing the digital content, the display engine may detect such dynamic changes in the and may communicate to the visual noise engine which dynamically updates the visual noise. For example, if a user scrolls down the digital content by a line, the noise which was displayed to the second line of the digital content must be displayed to the third line on the digital content which effectively becomes the second line of the digital content when displayed. It is to be observed that such changes made by the system by way of visual noise introduction are temporary i.e., the visual noise introduction will not modify the digital content. Similarly, the visual noise which is overlaid on top of a section or text of the digital content may get updated dynamically. For example, quarterly results that are announced by an organization is a confidential and internal information before the organization makes it public officially. When such documents are accessed by an user who is not an admin or not authorized to extract information from such confidential document, an employee number of the user may be overlaid with relation to confidential text and/or with alternate numerals of the profit or loss numbers after parsing and detecting the sensitive information, and when scrolled by the user, the display engine may detect change and update the visual noise dynamically through visual noise engine so that the visual noise is always intact with sensitive or confidential information to deter the leakage of such information by capturing image of the screen by external image capturing device.

In an example, if the digital content is an image, the user may pan or zoom the image and, in such instances, the digital display engine may detect such changes and send instructions to the visual noise engine which may dynamically update the visual noise to move or enlarge or shrink in synchronization with the digital content.

FIG. 4 is an exemplary digital content (a press release of ABC COMPANY' s quarterly results) wherein the digital content (which is a document) comprises a watermark—confidential. As described in various examples of the present disclosure, when the document is displayed through the display engine, the digital content detector may identify that the document is confidential through parsing the document which has watermark by name ‘confidential’ 402 and decide that visual noise to be introduced while displaying the digital content. The digital content detector may identify the portions of the digital content comprising confidential/sensitive information 404, 406, 408 and 410 which needs to be protected from leakage and may send instructions to the visual noise engine to fetch a visual noise based on user information and information on type of document that are stored mapped and stored at the enterprise database. The visual noise engine through the display engine may display the visual noise dynamically along with the digital content either to mask the sensitive information or the display user information at portions nearby the sensitive information, or modify any character in the digital content as per the pre-defined rules for the user or combination thereof, so that when the image of digital content is captured by external image capturing device and shared outside the organization, the visual noise introduced will help in backtrack and investigation to find out the person or the device associated with the user from where the sensitive information is leaked.

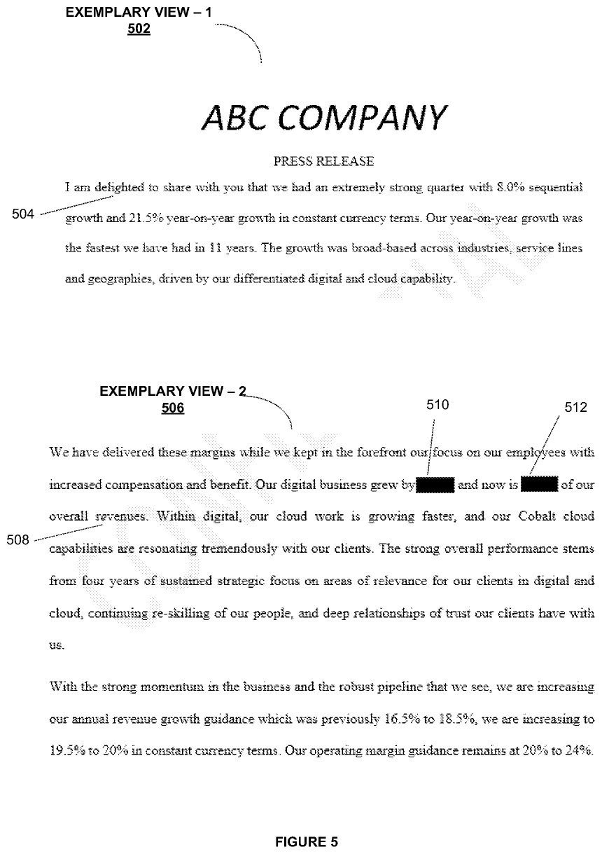

FIG. 5 illustrates dynamic introduction of visual noise in the confidential document (or digital content). Consider that a user with employee ID 122334 is mapped with a visual noise of a font style of tenth character in the third line of a confidential document may be changed to italic. Exemplary view—1 (502) which is one of the views at display screen of the digital device by the user with employee ID 122334 and the visual noise of changing the font style of tenth letter in the third row to italic is introduced (504) in the confidential document. Exemplary view—2 (506) is when the user has scrolled down the confidential document illustrated in FIG. 4, wherein visual noise of changing the font style of tenth letter in the third row to italic is introduced (508) in the confidential document. It is to be observed that the visual noise is introduced only for the viewed part of the digital content by the user. As the user views the Exemplary view—2 (506), the visual noise introduced in the Exemplary view—1(508) is removed. As described above, the visual noise is introduced only to that part of the document that shows up on the screen, and not the whole file. Alternatively, some of the confidential information may be masked (510, 512) based on per-defined rules or visual noise associated with the user as illustrated in FIG. 5.

In one or more examples, a non-transitory computer readable medium having stored thereon instructions for deterring data leakage through photographing of display screen by external camera, the non-transitory computer readable medium comprising machine executable code which when executed by at least one processor, causes the at least one processor to perform steps comprising, detecting a digital content displayed on the digital device, wherein the digital content is either or combination of an image or a text document. A classification type of the digital content that is displayed on the digital device may be identified. When the classification type of the digital content is one of the pre-defined types, an information of a user associated with the digital device may be obtained from the enterprise database based on which a visual noise to be displayed on the digital device is determined and fetched from the enterprise database. The fetched visual noise may be displayed along with the digital content to deter the leakage of information from the displayed digital content through image capture by an external image capturing device (or external camera). The visual noise that is displayed comprising either or combination of: modifying one or more characters in the digital content with the visual noise and/or overlaying the visual noise on the digital content.

The visual noise that are fetched from the enterprise database, which is unique for each user may be generated using a data pattern based on the information of the user and one or more pre-defined rules for the user associated with the digital device, wherein the visual noise is at least one or combination of alphanumeric characters special characters, and/or graphical content.

The advantage of the technology solution described in the present disclosure is that an organization can digitally watermark the part of the file that shows up on screen, with the visual noise either by modifying the text with the noise, or insert the visual noise as an watermark in the background or overlay the visual noise on the content in the digital document that should be unique and different for each user, so that at the time of investigation for theft/leakage of data/sensitive information, the organization can find out from which employee/user the data leaked, when an employee/user takes screenshot and makes it public.

The specification and drawings are to be regarded in an illustrative rather than a restrictive sense.

What is claimed is:

1. A computer implemented method for deterring data leakage through photographing of display screen by an external camera, comprising:
detecting, by a processor, a digital content when displayed on a digital device;
identifying, by the processor, a classification type of the digital content displayed on the digital device; and
when the classification type of the digital content is one of pre-defined types:
obtaining, by the processor, an information of a user associated with digital device from an enterprise database;
fetching, by the processor, a visual noise to be displayed on the digital device from the enterprise database based on the obtained information of the user; and
displaying, by the processor, the fetched visual noise along with the digital content on the digital device to deter leakage of information from the displayed digital content by the external camera.

2. The computer implemented method of claim 1, wherein the visual noise is generated using a data pattern based on the information of the user and one or more pre-defined rules for the user associated with the digital device.

3. The computer implemented method of claim 1, wherein the displaying the visual noise comprising either or combination of:
modifying, through the processor, at least one character in the digital content with the visual noise; or
overlaying, through the processor, the visual noise on the at least one character in the digital content.

4. The computer implemented method of claim 1, wherein the digital content at least one or combination of an image or a text document.

5. The computer implemented method of claim 1, wherein the visual noise is at least one or combination of alphanumeric characters, special characters, or a graphical content.

6. A system for deterring data leakage through photographing of display screen by an external camera, comprising:
at least one processor;
a digital device;
at least one memory unit operatively coupled to the at least one processor, having instructions stored thereon that, when executed by the at least one processor, causes the at least one processor to:
detect, a digital content when displayed on the digital device;
identify, a classification type of the digital content displayed on the digital device; and
when the classification type of the digital content is one of pre-defined types:
obtain, an information a user associated with digital device from an enterprise database;
fetch, a visual noise to be displayed on the digital device from the enterprise database based on the obtained information of the user; and
display, the fetched visual noise along with the digital content on the digital device to deter leakage of information from the displayed digital content by the external camera.

7. The system of claim 6, wherein the visual noise is generated using a data pattern based on the information of the user and one or more pre-defined rules for the user associated with the digital device.

8. The system of claim 6, wherein the displaying the visual noise comprising either or combination of:
modify, at least one character in the digital content with the visual noise; or
overlay, the visual noise on the at least one character in the digital content.

9. The system of claim 6, wherein the digital content at least one or combination of an image or a text document.

10. The system of claim 6, wherein the visual noise is at least one or combination of alphanumeric characters, special characters, or graphical content.

11. A non-transitory computer readable medium having stored thereon instructions for deterring data leakage through photographing of display screen by an external camera, the non-transitory computer readable medium comprising machine executable code which when executed by at least one processor, causes the at least one processor to perform steps comprising:
detecting, a digital content when displayed on a digital device;
identifying, a classification type of the digital content displayed on the digital device; and
when the classification type of the digital content is one of pre-defined types:
obtaining, an information of a user associated with digital device from an enterprise database;
fetching, a visual noise to be displayed on the digital device from the enterprise database based on the obtained information of the user; and
displaying, the fetched visual noise along with the digital content on the digital device to deter leakage of information from the displayed digital content by the external camera.

12. The non-transitory computer readable medium of claim 11, wherein the visual noise is generated using a data pattern based on the information of the user and one or more pre-defined rules for the user associated with the digital device.

13. The non-transitory computer readable medium of claim 11, wherein the displaying the visual noise comprising either or combination of:
modifying, at least one character in the digital content with the visual noise; or
overlaying, the visual noise on the at least one character in the digital content.

14. The non-transitory computer readable medium of claim 11, wherein the digital content at least one or combination of an image or a text document.

15. The non-transitory computer readable medium of claim 11, wherein the visual noise is at least one or combination of alphanumeric characters, special characters, or a graphical content.
